(19) United States
(12) Patent Application Publication
(10) Pub. No.: US 2026/0112945 A1
(43) Pub. Date: Apr. 23, 2026

(54) Stator Housing And Stator For An Axial Flux Machine

(71) Applicant: Schaeffler Technologies AG & Co. KG, Herzogenaurach (DE)

(72) Inventors: Marco Mechi, Rosignano Marittimo (IT); Daniel Marc, Livorno (IT); Davide Matteini, Livorno (IT)

(73) Assignee: Schaeffler Technologies AG & Co. KG, Herzogenaurach (DE)

(21) Appl. No.: 19/117,307

(22) PCT Filed: Sep. 6, 2023
(86) PCT No.: PCT/EP2023/074442

§ 371 Date: Mar. 31, 2025

(30) Foreign Application Priority Data
Sep. 30, 2022 (DE) 10 2022 210 419.6

(51) Int. Cl. H02K 9/197; H02K 1/16; H02K 1/20; H02K 3/24; H02K 3/47; H02K 5/02; H02K 5/20; H02K 21/24

(52) U.S. Cl. CPC H02K 9/197; H02K 1/165; H02K 1/20; H02K 3/24; H02K 3/47; H02K 5/02; H02K 5/203; H02K 21/24

(57) ABSTRACT

Various embodiments of the teachings herein include a stator housing for an axial flux machine with a rotor to rotate about an axis of rotation, a stator spaced apart from the rotor along the axis of rotation, and a fluidtight interior space containing coil receiving locations in a circumferential direction around the axis of rotation to receive electromagnetic coil assemblies, wherein each coil assembly has at least one coil wound axially around a stator tooth. An example includes: a liquid cooling system having a first cooling channel extending circumferentially in the stator housing; and a second cooling channel separate from the first and extending circumferentially in the stator housing; wherein the interior space holds a cooling liquid in thermal contact with cooling liquid in the first and the second cooling channel.

### CROSS-REFERENCE TO RELATED APPLICATIONS

This application is a U.S. National Stage Application of International Application No. PCT/EP2023/074442 filed Sep. 6, 2023, which designates the United States of America, and claims priority to DE Application No. 10 2022 210 419.6 filed Sep. 30, 2022, the contents of which are hereby incorporated by reference in their entirety.

### TECHNICAL FIELD

The present disclosure relates to stators. Various embodiments of the teachings herein include stator housings for an axial flux machine which has at least one rotor that can rotate about an axis of rotation and at least one stator spaced apart from the rotor along the axis of rotation and stators for such an axial flux machine.

### BACKGROUND

Axial flux machines, also referred to as disk motors, are gaining in importance owing to their high power density and other favorable properties and are also of increasing interest as drives for electrically driven vehicles. In the case of such motors, the rotor is typically in the form of a disk and is rotatably mounted about an axis of rotation, the magnetic field generated extending substantially parallel to the axis of rotation.

Such axial flux machines are known for example from WO 2010/092400 and US 2015/0364956. The axial flux machines disclosed in those documents are what are referred to as YASA (yokeless and segmented armature) motors, the stator of which does not have a magnetic yoke and which have a segmented armature. In the case of relatively compact stators of this design, the dissipation of heat generated during operation is a particular challenge.

### SUMMARY

Teachings of the present disclosure include stators for an axial flux machine, in the case of which stator heat that is generated during operation can be dissipated efficiently. For example, some embodiments of the teachings herein include a stator housing (1) for an axial flux machine comprising at least one rotor that can rotate about an axis of rotation (2) and at least one stator (30) which is spaced apart from the rotor along the axis of rotation (2) and has a fluidtight interior space (8), wherein the interior space (8) contains coil receiving locations (10) in the circumferential direction around the axis of rotation (2) for receiving electromagnetic coil assemblies (31), wherein each coil assembly (31) has at least one coil (35) wound axially around a stator tooth (33), wherein the stator housing (1) has a liquid cooling system comprising at least one first cooling channel (17) extending circumferentially in the stator housing (1) and at least one second cooling channel (19) which is separate from the first and also extends circumferentially in the stator housing (1), wherein the interior space (8) is filled with a cooling liquid, which is in thermal contact with cooling liquid in the first and the second cooling channel (17, 19).

In some embodiments, the interior space (8) is fluidtightly sealed and does not have any openings toward the outside, with the result that a cooling liquid is fluidtightly enclosed in the interior space (8).

In some embodiments, the liquid cooling system further comprises: at least one inlet opening (14), in fluid connection with the first cooling channel (17), for the entry of cooling liquid into the interior space (8), and at least one outlet opening (14), in fluid connection with the second cooling channel (19), for the exit of cooling liquid from the interior space (8), with the result that a cooling liquid can flow from the first cooling channel (17) into the interior space (8) and from there into the second cooling channel (19).

In some embodiments, the stator housing (1) further comprises an outer housing component (3) and an inner housing component (4), wherein the inner housing component (4) is arranged concentrically inside the outer housing component (3), and the at least one first cooling channel (17) and the at least one second cooling channel (19) are formed between the inner housing component (4) and the outer housing component (3).

In some embodiments, the at least one first cooling channel (17) and/or the at least one second cooling channel (19) are/is in the form of a depression in an outer side (23) of the inner housing component (4).

In some embodiments, the at least one first cooling channel (17) extends substantially semicircularly in a first half of the stator housing (1) and the at least one second cooling channel (19) extends substantially semicircularly in a second half of the stator housing (1), wherein the first half and the second half are situated opposite one another along a plane of symmetry containing the axis of rotation (2), and wherein a plurality of inlet openings (14) are arranged along the first cooling channel (17) and a plurality of outlet openings (14) are arranged along the second cooling channel (19).

In some embodiments, separating ribs (9) extend from the outside to the inside, between the coil receiving locations (10), into the interior space (8), wherein the separating ribs (9) have the at least one inlet opening (14) and the at least one outlet opening (14).

In some embodiments, the stator housing (1) further comprises, for each coil receiving location (10), a positioning aid (13) for positioning, or centering, a stator tooth (33).

As another example, some embodiments include a stator (30) for an axial flux machine, comprising a stator housing (1) as described herein and a plurality of electromagnetic coil assemblies (31) arranged on the coil receiving locations (10), wherein the stator housing (1) is partially potted with a plastics potting compound.

In some embodiments, on at least one side of the stator (30) there is a covering plate (40), and intermediate spaces (38) between the covering plate (40) and elements of the stator (30) are potted with a plastics potting compound.

In some embodiments, located between the covering plate (40) and an inner annular element (15) of the stator housing (1) and an outer annular element (16) of the stator housing (1) are O-rings (36, 37) in the form of seals.

As another example, some embodiments include an axial flux machine comprising at least one stator (30) as described herein.

### BRIEF DESCRIPTION OF THE DRAWINGS

Embodiments of the invention are described by way of example below using schematic drawings.

FIG. 1 shows a side view of an example stator housing incorporating teachings of the present disclosure;

FIG. 2 shows a perspective side view of the stator housing according to FIG. 1;

FIG. 3 shows a side view, from the opposite side, of the stator housing according to FIG. 1;

FIG. 4 shows a view slightly in perspective, from the same side as FIG. 3, of the stator housing;

FIG. 5 shows the same view of the stator housing as FIG. 3, but depicts only an inner housing component;

FIG. 6 shows the same view of the stator housing as FIG. 4, but depicts only an inner housing component of the stator housing;

FIG. 7 shows the same view of the stator housing as FIG. 3, but coil assemblies have been inserted into the stator housing and partially potted with a plastics compound;

FIG. 8 shows a perspective view of the stator housing with the coil assemblies according to FIG. 7;

FIG. 9 shows a detail of an example stator incorporating teachings of the present disclosure; and

FIG. 10 shows a sectional view of the stator according to FIG. 9.

### DETAILED DESCRIPTION

Teachings of the present disclosure include stator housings for an axial flux machine, wherein the axial flux machine comprises at least one rotor that can rotate about an axis of rotation and at least one stator which is spaced apart from the rotor along the axis of rotation and has a fluidtight interior space, wherein the interior space contains coil receiving locations in the circumferential direction around the axis of rotation for receiving electromagnetic coil assemblies, wherein each coil assembly has at least one coil wound axially around a stator tooth.

The stator housing has a liquid cooling system comprising at least one first cooling channel extending circumferentially in the stator housing and at least one second cooling channel which is separate from the first and also extends circumferentially in the stator housing. The interior space is filled with a cooling liquid, which is in thermal contact with cooling liquid in the first and the second cooling channel.

The thermal contact can be a direct contact in the form of a flow connection between the cooling channels and the interior space, with the result that the cooling liquid can move between the cooling channels and the interior space and thus transport heat. In some embodiments, the interior space is fluidtightly sealed such that it cannot exchange cooling liquid with the cooling channels. In both cases, however, an exchange of heat energy between cooling liquid in the cooling channels and cooling liquid in the interior space is possible.

In some embodiments, the interior space is fluidtightly sealed and does not have any openings toward the outside, with the result that a cooling liquid is fluidtightly enclosed in the interior space. In this embodiment, it is possible to use different cooling liquids, one circulating in the cooling channels and another being enclosed in the interior space. If use is made in the interior space of, for example, a dielectric (electrically insulating) cooling liquid, it can be brought into direct contact with the coils, while at the same time a conventional coolant can be used in the cooling channels. The immersion cooling has the advantage that the coolant in the interior space can take up thermal energy very readily.

In some embodiments, the liquid cooling system further comprises at least one inlet opening, in fluid connection with the first cooling channel, for the entry of cooling liquid into the interior space, and at least one outlet opening, in fluid connection with the second cooling channel, for the exit of cooling liquid from the interior space, with the result that a cooling liquid can flow from the first cooling channel into the interior space and from there into the second cooling channel. A fluidtight interior space of the stator is understood to be a cavity which is inside the stator and is fluidtight except for its inlet and outlet openings which are part of the liquid cooling system, so the cooling liquid can flow into the interior space and back out again without leaving the liquid cooling system. The cooling liquid of the liquid cooling system can therefore circulate in the interior space and thus ensure an efficient dissipation of heat. The interior space of the stator is in particular partially delimited by the electric coil assemblies, in particular by the stator teeth bearing the windings. This has the effect that the cooling liquid can come into close contact with the heat sources. The cooling liquid used can be an electrically insulating cooling liquid, for example an oil.

The stator housing may in particular be made of metal, for example aluminum, and thus have a very good heat conductivity. As an alternative, however, it is also possible to use non-metallic materials, for example plastic, for the stator housing, and that makes it possible to reduce losses owing to eddy currents.

The liquid cooling system with the coolant, which circulates in the fluidtight interior space, is fed to the interior space through the first cooling channel and is discharged from the interior space through the second cooling channel, enables a particularly good dissipation of heat generated during operation.

In some embodiments, the cooling liquid to be able to come into direct contact in the fluidtight interior space with the components, i.e. the coil assemblies, that are to be cooled. This reduces the number of times heat is exchanged between materials and thus improves the transport of heat.

In some embodiments, the stator housing comprises an outer housing component and an inner housing component, wherein the inner housing component is arranged concentrically inside the outer housing component, and the at least one first cooling channel and the at least one second cooling channel are formed between the inner housing component and the outer housing component.

In some embodiments, the at least one first cooling channel and/or the at least one second cooling channel are/is in the form of a depression in an outer side of the inner housing component. The coolant circulates at least partially along a circumference of the stator housing. The two-part form of the housing with an outer housing component and an inner housing component, the cooling channels being located between the housing components and being in the form of a depression in an outer side of the inner housing component or alternatively in the form of a depression in an inner side of the outer housing component, means that the housing can be produced and assembled very easily.

In some embodiments, the at least one first cooling channel extends substantially semicircularly in a first half of the stator. The at least one second cooling channel extends substantially semicircularly in a second half of the stator, wherein the first half and the second half are situated opposite one another along a plane of symmetry containing the axis of rotation, and wherein a plurality of inlet openings are arranged along the first cooling channel and a plurality of outlet openings are arranged along the second cooling channel. The two cooling channels extend along virtually the entire circumference of the stator housing. In the first half of the stator, coolant is fed via the first cooling channel and enters the interior space through outlet openings arranged along the first cooling channel. In the interior space, the coolant takes up heat and passes through the outlet openings in the second half of the stator out of the interior space and into the second cooling channel, from where it can be dissipated. For the circulation of the coolant, in particular a corresponding coolant pump is provided.

In some embodiments, separating ribs extend from the outside to the inside, between the coil receiving locations, into the interior space, wherein the separating ribs have the at least one inlet opening and the at least one outlet opening. The individual coil receiving locations are separated from one another, at least in an outer region of the stator, by separating ribs, which can be made in particular of metal. The separating ribs in particular do not protrude into the interior space as far as the center, i.e. as far as the axis of rotation, but instead extend inward only over for example one third or half of the radius. The separating ribs can in particular be substantially hollow and their tips protruding into the interior space can have inlet, or outlet, openings.

The separating ribs, which may be made in particular of metal and thus have a good heat conductivity, serve both to feed the coolant into the interior space and to take up heat directly from the coil assemblies, with which they are in heat-conductive contact.

In some embodiments, the stator housing further comprises, for each coil receiving location, a positioning aid for positioning, or centering, a stator tooth. This has the advantage of making it easier to exactly position the stator teeth. This is important in particular in terms of the air gap, which must be dimensioned as exactly as possible, between the stator and the rotor of the axial flux machine. The positioning aid can be designed for example as a formation which is on the stator housing and interacts with a corresponding opening in or formation on the stator teeth.

Some embodiments of the teachings herein include a stator for an axial flux machine comprising the above-described stator housing and a plurality of electromagnetic coil assemblies arranged on the coil receiving locations, wherein the stator housing is partially potted with a plastics potting compound. The plastics potting compound is arranged in the stator housing in particular such that it partially connects the coil assemblies to one another. In particular, it embeds the outer regions of the coil assemblies. The inner regions of the coil assemblies, i.e. the stator teeth provided with the windings, protrude into the interior space of the stator housing, this interior space being fluidtightly sealed by the plastics potting compound in the outer region of the stator housing. It is also possible to partially pot separating ribs between the coil receiving locations, in order to seal off intermediate spaces between the separating ribs and the coil assemblies. The inlet openings and outlet openings, if present, in the separating ribs remain free of the plastics potting compound. Electrical supply lines to the coil assemblies, by contrast, can be conjointly potted and thus sealed off.

The stator has a particularly efficient cooling system and heat generated during operation can thus be dissipated particularly well. The sealing of the interior space by potting certain regions with a plastics compound allows the cooling liquid to freely circulate in the rest of the regions of the interior space, without it being necessary to provide a further encapsulation of the liquid cooling system in the interior space. This results in a particularly good exchange of heat between the coil assembly and the cooling liquid.

In some embodiments, on at least one side of the stator there is a covering plate, and intermediate spaces between the covering plate and elements of the stator are potted with a plastics potting compound. The stator, which is in the form of a flat cylinder, has, in addition to its lateral surface, two disk-shaped sides which also delimit the interior space and thus must be sealed. For this, a respective covering plate that also can be made of metal and thus has good heat conduction properties may be provided.

In some embodiments, located between the covering plate and an inner annular element of the stator housing and an outer annular element of the stator housing are O-rings in the form of seals, wherein the O-rings may in particular be in the form of rubber seals. The inner annular element of the stator housing may in particular be a ring which surrounds the axis of rotation of the rotor. The outer annular element may in particular be the outer lateral surface of the stator housing. The interior space in which the cooling liquid can circulate is delimited and fluidtightly sealed by the inner annular element, by the covering plate(s) potted with plastics potting compound and the outer annular element also potted with plastics potting compound, and by the stator teeth protruding into the interior space.

As another example, some embodiments include an axial flux machine comprising the above-described stator. In addition, the axial flux machine also comprises at least one rotor, which in particular may be brushless, and may comprise permanent magnets which interact with the magnetic field of the stator.

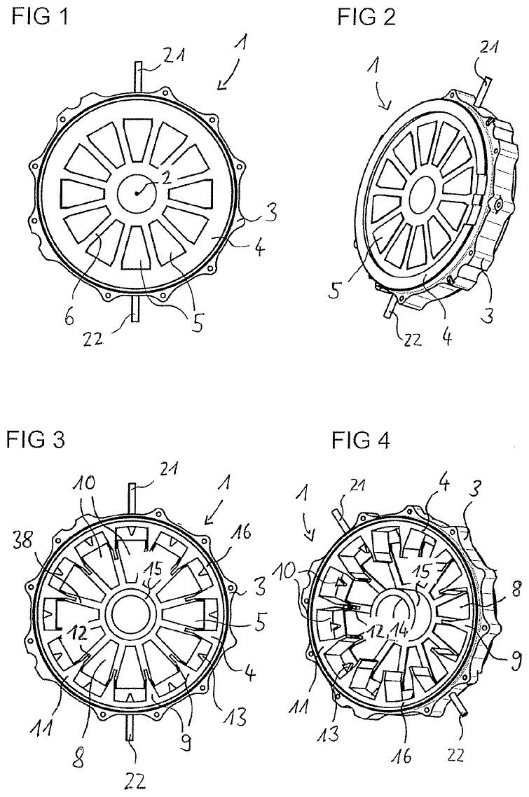

FIGS. 1 and 2 show views, from a first side, of an example stator housing 1 of an axial flux motor incorporating teachings of the present disclosure. The stator housing 1 is substantially rotationally symmetrical about an axis of rotation 2 of an associated rotor, not shown in the figures, of the axial flux motor. The stator housing 1 has an outer housing component 3 and an inner housing component 4, wherein the outer housing component 3 concentrically surrounds the inner housing component 4 and an inner side of the outer housing component 3 is in contact with an outer side of the inner housing component 4. The stator housing 1 substantially has the form of a flat cylinder, the cylinder not having a covering but initially being open on one side, and the base having a series of apertures 5 separated from one another by dividers 6.

The stator housing 1 has a liquid cooling system for an interior space, not shown in FIGS. 1 and 2, of the stator housing 1 which has a feed line 21 and a return line 22 through which a liquid coolant is pumped during operation.

FIGS. 3 and 4 show views of the stator housing 1 according to FIGS. 1 and 2, but the view is depicted through the open covering surface into an interior space 8 of the stator housing 1. The interior space 8 of the stator housing 1 contains twelve coil receiving locations 10 overall. As an alternative-depending on the design of the motor-it is also possible to provide more or fewer coil receiving locations. The coil receiving locations 10 are rotationally symmetrical about the axis of rotation, or about an inner annular element 15 of the stator housing 1, and are separated from one another by separating ribs 9.

The separating ribs 9 accordingly divide the interior space 8 of the stator housing 1 into twelve coil receiving locations 10. There are therefore also twelve separating ribs 9, which extend inward from an outer annular element 16 of the stator housing 1 and extend inward over approximately one third of the radius of the stator housing 1. The separating ribs 9 are connected to, in particular formed in one piece with, the outer annular element 16.

The stator housing 1 with the outer housing component 3 and the inner housing component 4, the inner housing component 4 comprising the outer annular element 16, the separating ribs 9, the dividers 6 and the inner annular element 15, is made of metal, for example aluminum, and therefore conducts heat very well.

The separating ribs 9 are, as can be seen in the perspective view in FIG. 4, at least partially hollow and their inwardly protruding tips have inlet, or outlet, openings for a liquid coolant. The separating ribs 9 have wider outer regions 11 than inner regions 12; accordingly, the separating ribs taper toward the middle of the stator housing 1 to a tip.

Furthermore, each coil receiving location 10 has a positioning aid 13 in the form of a tip which protrudes into the interior space 8 and serves for correctly positioning a stator tooth to be positioned on the coil receiving location 10.

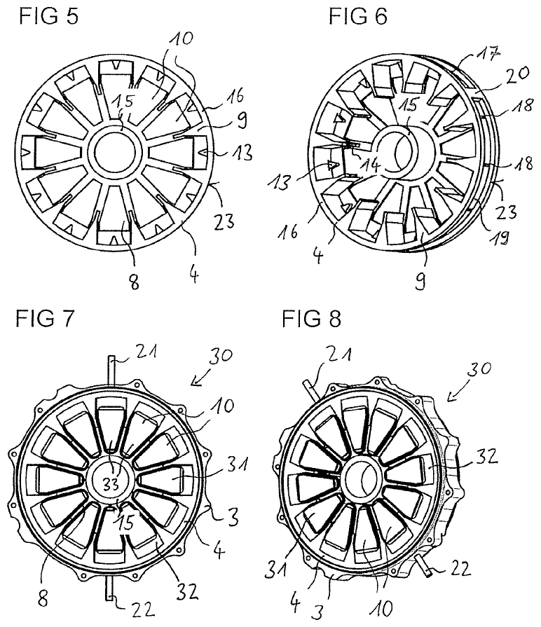

FIGS. 5 and 6 show views of the inner component 4. It is evident in these views, by contrast to those shown in FIGS. 3 and 4, that located in an outer side 23 of the inner housing component 4 are a first cooling channel 17 and a second cooling channel 19, which each extend around virtually half of the circumference of the inner housing component 4 and are in the form of depressions in the inner housing component, or in the outer side 23 thereof. A separating divider 20 separates the first cooling channel 17 from the second cooling channel 19. In the cooling channels 17, 19, apertures 18 are provided in the hollow separating ribs 9. Accordingly, the first cooling channel 17 and the second cooling channel 19 are in fluid connection with the interior space 8 of the stator housing 1 via the cavity in the separating ribs 9.

FIGS. 7 and 8 show views of the stator 30 of an axial flux motor incorporating teachings of the present disclosure, twelve assemblies 31 being positioned on the coil receiving locations 10 in the stator housing 1 of the stator 30. The coil assemblies 31 comprise in particular a respective stator tooth 33 made of a magnetic material and a coil 35, which is wound axially around the stator tooth 33.

During operation, cooling liquid flows through the feed line 21 into the first cooling channel 17, from there through apertures 18 into the separating ribs 9 and through the inlet openings 14 into the interior space 8 of the stator housing 1. The coolant, for example oil, flows around large regions of the coil assemblies 31. The coolant flows back out of the interior space 8 through openings 14 in separating ribs 9, which are in fluid connection with the second cooling channel 19, and is discharged through the return line 22.

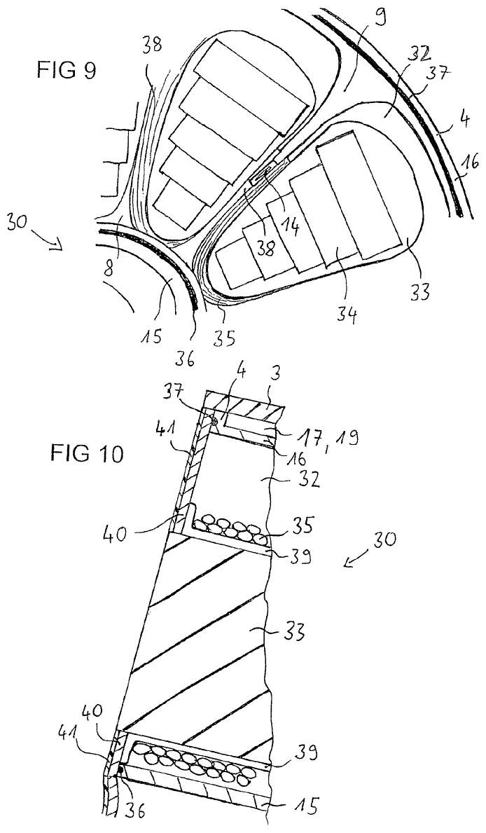

FIG. 9 Shows a detail of the stator 30 in a top view, as in FIGS. 7 and 8, although FIG. 9 does not depict the outer housing component 3. The stator teeth 33 are formed by a number of stacked sheet layers 34, in order to reduce eddy currents. As an alternative, they may also for example be made of an epoxy resin-bound powder (also referred to as SMC material, which stands for soft magnetic compound).

Around their circumference, the stator teeth 33 have the windings of the coils 35. Electrical supply lines are not shown in FIG. 9; they may in particular be located in the outer region 11 of the stator teeth 33. Located between the laminated core of the stator tooth 33 and the coil 35 is an insulation 39, which is depicted in FIG. 10.

In order to fluidtightly seal the interior space 8, the outer region of the stator housing 1 is potted with a potting compound 32 after the coil assemblies 31 have been inserted. The potting compound fills in particular the volume between the outer annular element 16, the coil assemblies 31 and the separating ribs 9. The potting compound partially fills intermediate spaces 38 between the coil assemblies 31, but do not extend as far inward as the separating ribs 9 do, with the result that the inlet, or outlet, openings 14 remain free of the potting compound.

In order to seal the interior space 8 with respect to a covering plate, not shown in FIG. 9, an O-ring 36 made of a resiliently elastic material is inserted in a depression of the inner annular element 15 and a further O-ring 37 is inserted in a depression of the outer annular element 16.

FIG. 10 shows a section through the stator 30 according to FIG. 9, which additionally shows the outer housing component 3 and a covering plate 40. The covering plate 40, which in the embodiment shown has apertures at the positions of the stator teeth 33, is placed onto the stator housing 1 after the potting compound 32 is introduced. Then, a thin layer 41 of potting compound can be applied to the entire front side of the stator 30, if appropriate omitting the regions of the stator teeth 33, in order to fluidtightly seal intermediate spaces between the covering plate 40 and other elements of the stator housing 1.

The interior space 8 of the stator 30 is thus fluidtightly sealed and, except for the inlet, or outlet, openings 14 does not have any openings to the outside, with the result that liquid coolant can flow through it during operation. Since the coolant is in direct contact with large regions of the coil assemblies 31, the dissipation of heat is particularly efficient.

1. A stator housing for an axial flux machine with a rotor to rotate about an axis of rotation, a stator spaced apart from the rotor along the axis of rotation, and, a fluidtight interior space containing coil receiving locations in circumferential direction around the axis of rotation to receive electromagnetic coil assemblies, wherein each coil assembly has at least one coil wound axially around a stator tooth,
the stator housing comprising:
a liquid cooling system
having a first cooling channel extending circumferentially in the stator housing; and
a second cooling channel separate from the first and extending circumferentially in the stator housing;
wherein the interior space holds a cooling liquid in thermal contact with cooling liquid in the first and the second cooling channel.

2. The stator housing as claimed in claim 1, wherein the interior space is sealed and without any openings to a surrounding of the housing, so the cooling liquid is entrapped in the interior space.

3. The stator housing as claimed in claim 1, wherein the stator housing further comprises:
an inlet opening in fluid connection with the first cooling channel for entry of cooling liquid into the interior space; and
an outlet opening in fluid connection with the second cooling channel for the exit of cooling liquid from the interior space;
so a cooling liquid can flow from the first cooling channel into the interior space and from there into the second cooling channel.

4. The stator housing as claimed in claim 1 , further comprising:
an outer housing component;
an inner housing component arranged concentrically inside the outer housing component;
wherein the first cooling channel and the second cooling channel are formed between the inner housing component and the outer housing component.

5. The stator housing as claimed in claim 4, wherein at least one of the first cooling channel and the second cooling channel comprises a depression in an outer side of the inner housing component.

6. The stator housing as claimed in claim 1, wherein:
the first cooling channel extends substantially semicircularly in a first half of the stator housing; and
the second cooling channel extends substantially semicircularly in a second half of the stator housing;
the first half and the second half are situated opposite one another along a plane of symmetry containing the axis of rotation; and
a plurality of inlet openings are arranged along the first cooling channel and a plurality of outlet openings are arranged along the second cooling channel.

7. The stator housing as claimed in claim 4, further comprising separating ribs extending from the outside to the inside, between the coil receiving locations, into the interior space;
wherein the separating ribs have the inlet opening and the outlet opening.

8. The stator housing as claimed in claim 1, further comprising, for each coil receiving location, a respective positioning aid for positioning a stator tooth.

9. A stator for an axial flux machine, the stator comprising:
a liquid cooling system having first cooling channel extending circumferentially in the stator housing; and
a second cooling channel separate from the first and extending circumferentially in the stator housing;
wherein the interior space holds a cooling liquid in thermal contact with cooling liquid in the first and the second cooling channel; and
a plurality of electromagnetic coil assemblies arranged on the coil receiving locations;
wherein the stator housing is at least partially potted with a plastics potting compound.

10. The stator as claimed in claim 9, further comprising:
a covering plate on at least one side of the stator;
wherein intermediate spaces between the covering plate and elements of the stator are potted with a plastics potting compound.

11. The stator as claimed in claim 9, further comprising o-rings located between the covering plate and an inner annular element of the stator housing and an outer annular element of the stator housing.

12. (canceled)
